(19) United States
(12) Patent Application Publication
(10) Pub. No.: US 2026/0351681 A1
(43) Pub. Date: Nov. 5, 2026

(54) Electrochemical Storage Cell and Method for Adjusting a Compression Pressure of an Electrochemical Storage Cell

(71) Applicant: Bayerische Motoren Werke Aktiengesellschaft, Muenchen (DE)

(72) Inventors: Michael BUHL, Grafing (DE); Simon ERHARD, Geltendorf (DE); Attila FARKAS, Muenchen (DE)

(21) Appl. No.: 19/486,265

(22) PCT Filed: May 13, 2024
(86) PCT No.: PCT/DE2024/100426

§ 371 Date: Nov. 20, 2025

(30) Foreign Application Priority Data
Jun. 12, 2023 (DE) 10 2023 115 208.4

(51) Int. Cl. H01M 10/0585; H01M 10/0525; H01M 10/613; H01M 50/107; H01M 50/202; H01M 50/213; H01M 50/238

(52) U.S. Cl. CPC H01M 10/0585; H01M 10/0525; H01M 10/613; H01M 50/107; H01M 50/202; H01M 50/213; H01M 50/238

(57) ABSTRACT

An electrochemical storage cell comprises a housing having an outer housing casing that includes a bellows. An electrode stack is arranged in an interior of the housing. A first pressure plate connected to the outer housing casing is configured to exert a compression pressure on the electrode stack with the aid of elastic deformation of the bellows.

### BACKGROUND AND SUMMARY

The following description relates to an electrochemical storage cell having a spring-loaded compression device for compensating for expansion of stacked electrochemical storage cells in the stacking direction. Furthermore, a method for adjusting a compression pressure of an electrochemical storage cell is described.

### PRIOR ART

Solid-state batteries are a particular type of accumulators in which the electrodes and the electrolyte consist of solid material. All-solid-state batteries are increasingly viewed as an important module for the electrification of mobility. They are considered to be safer and permit more range and shorter charging times than conventional lithium ion accumulators. Furthermore, lithium silicon batteries are increasingly being developed, in which an anode based on silicon and lithium ions are used as charge carriers.

One known problem in the battery technology of storage cells such as all-solid-state batteries and lithium silicon batteries relates to variable layer thicknesses. For example, in anode-free all-solid-state batteries (ASSB), in the discharged state, there is initially no anode formed on the anode side, but only a current collector (for example a copper foil) is present. In the charged state, an anode in the form of pure lithium is formed which, during the charging operation, migrates from the cathode (lithium is stored in the cathode) through a separator and is deposited or formed on the copper foil. In order to start up the cell, the electrode layers have to be pressed together. The necessary forces lie in the kN range or the pressures in the two-digit bar range).

The prior art offers solutions for these problems. However, there remains a technical challenge to maintain the compression forces or pressures that are set once within specific limits, in particular in electrode stacks with variable layer thicknesses. If, for example, the forces in the cell are designed for a charged state, the corresponding forces would be too low in the intermediate states between the charged and discharged state. The cell could not function correctly. If the forces in the cell are designed for the discharged state, the compression forces or pressures would be too high in the intermediate states between the charged and the discharged state. The cell could rupture.

Constant compression of the layers of an electrode stack can be achieved pneumatically or hydraulically. However, this has the result that either all the cells have to be supplied with a pressure unit or appropriate modules with a plurality of cells with a pump or pressure unit in each case. This is complicated and needs a great deal of space in order, for example, to be able to compensate for the expansion of individual cells or a plurality of cells in the module. Hydraulic or pneumatic systems would have to be supplied continuously with energy in order to keep the pressing forces constant even over longer service lives. These systems can tend to leak, a piping system must be supplied with oil and occupies valuable overall space.

One object includes specifying an electrochemical storage cell which can be operated with a more easily adjustable and maintainable compression pressure. In addition, a method for adjusting a compression pressure of an electrochemical storage cell is to be specified.

This object may be achieved by an electrochemical storage cell and a storage cell module according to the independent and subordinate claims. Advantageous embodiments and developments are evident from the dependent claims.

### SUMMARY

The following is based on the assumption that each feature which is described in relation to an arbitrary embodiment can be used on its own or in combination with other features described herein and can be used in combination with one or more features of another arbitrary embodiment or in any desired combination of another arbitrary embodiment, if this is not described explicitly as an alternative. Furthermore, equivalents and modifications which are not described below can be used without departing from the area of application of the claimed subjects.

In the following, an electrochemical storage cell designates an energy store on an electrochemical basis, in particular a rechargeable energy store, which is suitable to store electrical energy and to discharge it to a consumer, for example a consumer in a vehicle. An electrochemical all-solid-state cell is an all-solid-state battery, such as a lithium ion battery, so that the following description also relates to a lithium ion all-solid-state battery. A solid is to be understood as a chemical substance which, at the temperatures usually prevailing in an electrochemical storage cell, is rigid or at least exhibits a very low tendency to flow, as can be the case in polymers, for example.

In the following, the term “lithium ion battery” is used synonymously for all the designations, common in the prior art, for lithium-containing galvanic elements and electrochemical storage cells such as, for example, lithium battery, lithium cell, lithium ion cell, lithium polymer cell, lithium ion battery cell and lithium ion accumulator. In particular, chargeable batteries, what are known as secondary batteries, are included. In addition, the terms “battery” and “electrochemical storage cell” are used synonymously with the terms “lithium ion battery” and “lithium ion cell”.

The term “electrode stack” designates a sequence of layers or foils. In an electrochemical storage cell, the layers follow one another. However, this does not mean that the layers specified here must follow one another directly. Instead, it is also possible for intermediate layers to be provided such as, for example, a separator, insulator, electrode binder, coatings and electrical conductivity additives, which can be applied to an electrically conductive carrier of the respective electrodes.

An electrochemical storage cell typically has various electrodes, a positive electrode (cathode) and a negative electrode (anode), which can be contacted electrically via current collectors. Each of these electrodes has at least one active material, optionally together with additives such as electrode binders and electrical conductivity additives, which are applied to an electrically conductive carrier (for example a metal foil) or to a current collector of the respective electrodes. Typically, non-porous and solid conductor foils made of aluminum (for the positive electrode) or copper (for the negative electrode) are used as an electrically conductive carrier.

Such conductor foils are typically impermeable to liquid electrolyte and gases. The electrochemical storage cells described below can be used with a liquid electrolyte or configured with an all-solid-state electrolyte as electrochemical all-solid-state storage cells, for example as a ceramic or polymer-based all-solid-state battery. An electrochemical all-solid-state cell comprises an all-solid-state electrolyte.

An electrochemical storage cell which has means for compensating for compression pressure changes because of expansion of an electrode stack in the stacking direction is proposed below.

According to one embodiment of the disclosure, an electrochemical storage cell comprises a housing. The housing has an outer housing casing which comprises a bellows. An electrode stack is arranged in an interior of the housing. A first pressure plate is connected to the outer housing casing and is designed to exert a compression pressure on the electrode stack, mediated by elastic deformation of the bellows.

The electrochemical storage cell can be arranged in a round housing (as a round cell). The housing is cylindrical, for example, and has a circular cross section. The further components in the housing, in particular the electrode stack, can preferably likewise have a circular cross section. The electrode stack can have a liquid electrolyte added or the electrode stack is provided with an all-solid-state electrolyte, which is impressed into the layer sequence of the electrode stack. In this way, an electrochemical all-solid-state storage cell (ASSB for short or all-solid-state battery) can be formed.

The bellows, also called a corrugated tube, has the outer housing casing which has a diameter that alternates in a wave-shaped manner. For example, the housing is made of metal, so that the bellows is also designated a metal bellows or corrugated metal tube. In one embodiment, the housing is implemented as a round cell. The bellows has a circular cross section and, in the housing, encloses with the outer housing casing a cylindrical housing volume in which the electrode stack is arranged. The housing and thus the bellows can have other cross sections and geometries; for example, the housing and the bellows can have a polygonal cross section such as a hexagonal cross section. The storage cell, for example formed as a round cell, is a storage cell which can be produced inexpensively and time-effectively. The round cell permits flat contact between contacting elements and the respective electrode, which is electrically connected to the respective contacting element. The bellows can be described as a spring element with a Hook spring constant, which can be deformed elastically because of its material properties and geometry.

Depending on the state of charge of the electrochemical storage cell, the electrode stack can have different layer thicknesses. These layer thicknesses can “compress” or “relieve” the stack (“compress”: the cell is discharged, “relieve”: the cell is charged; for example, the anode layers can be formed as a function of the state of charge) by way of the spring action. The bellows is designed to track the pressure changes in the electrochemical storage cell, for example as a result of expansion and contraction of the electrode stack as a result of charging and discharging operations, and to adjust them to the desired compression pressure.

The disclosure is based in particular on the considerations presented below. One aspect relates to an electrochemical storage cell which permits the layer height of the electrode stack to be adjusted and tracked continuously without needing energy. The bellows represents a mechanical spring and can be elastically deformed in accordance with its mechanical properties. In other words, the bellows corresponds to a spring-loaded compression device. With an initial deformation, a compression pressure of a specific magnitude can be set on the electrochemical storage cell. This is done, for example, by a compression tool which engages on the housing during the assembly or production of the cell in corresponding bellows waves of the bellows and thus deflects the bellows into a position which corresponds to a specific deflection of the “spring” or a desired compression pressure. If the housing is closed in the state thus established, the compression pressure acts on the electrode stack. Changes in the layer height of the electrode stack can be readjusted continuously by the spring action of the bellows, without needing external energy.

According to one embodiment, the first pressure plate is arranged in the housing such that it can move along a stacking direction of the electrode stack and is firmly connected to a housing base. The first pressure plate is designed to exert the compression pressure on an underside of the electrode stack, mediated by the elastic deformation of the bellows.

For example, the first pressure plate is connected to the outer housing casing. The outer housing casing and the first pressure plate can be made from one piece or alternatively be screwed to each other or mechanically connected in another way (for example welded or crimped). The bellows can thus move the pressure plate in the housing along the stacking direction of the electrode stack. This movement is carried out as a function of the elastic deformation of the bellows, i.e. the spring action or deflection of the latter. The pressure plate thus imparts the compression pressure to the electrode stack. The first pressure plate can be designated as a movable “pressure disk.”

According to one embodiment, a second pressure plate is connected to a housing cover such that it cannot move in the housing, and rests on an upper side of the electrode stack. The second pressure plate is designed to exert a pressure on the electrode stack that is opposed to the compression pressure.

The outer housing casing and the housing cover can be made from one piece or alternatively screwed to each other or mechanically connected in another way (for example welded or crimped). The second pressure plate is mechanically fixedly arranged in the housing, so that the pressure plate is in effective mechanical contact with an upper side of the electrode stack and is designed to exert an opposing pressure to the compression pressure on the upper side of the electrode stack. The electrode stack can thus be pressed between the two pressure plates according to the compression pressure, established by the bellows, in the housing.

According to one embodiment, the housing is designed with double walls and comprises a housing interspace which is delimited by the outer housing casing and an inner housing casing. The electrode stack is arranged in an interior of the housing that is delimited by the inner housing casing 11. Furthermore, the housing interspace is designed to accommodate a temperature control fluid.

The housing comprises, for example, an outer wall which is formed by the outer housing casing. The outer wall thus has at least to some extent the shape and function of the bellows. The outer wall is a spring which compresses the layers of the electrode stack according to the compression pressure. An inner wall is formed, for example, by the inner housing casing. In the example of a round cell, the inner wall encloses a cylindrical housing volume in which the electrode stack is arranged. In other words, the inner wall is at least partly the lateral surface of a cylindrical cell. The housing interspace is formed as a cavity between the inner wall and outer wall and can accommodate a temperature control fluid. Thus, for example, immersion cooling can be implemented. The electrochemical storage cell can be particularly effectively cooled via the outer housing casing which, because of the bellows, has an enlarged surface.

According to one embodiment, the housing base is double-walled and designed to accommodate the temperature control fluid. An inner wall of the double-walled housing base is connected to the inner housing casing. An outer wall of the double-walled housing base is connected to the outer housing casing. The first pressure plate is connected to the inner and the outer wall of the double-walled housing base via a common connection point.

The double-walled housing base expands the receptacle for the temperature control fluid and therefore the area provided for the cooling. The pressure plate is coupled to the double-walled housing base via the common connection point and can be moved by the bellows according to the set compression pressure. For this purpose, the inner wall of the housing base can be configured flexibly, for example by material and/or structure, in order to support movement.

According to one embodiment, the inner wall of the double-walled housing base comprises a corrugated diaphragm plate.

The underside of the storage cell or the inner wall of the double-walled housing base is a corrugated diaphragm plate (preferably made of metal). The diaphragm plate is corrugated and thus ensures elasticity between various states of charge of the cell. One advantage of the diaphragm plate resides in the fact that the plate can be mechanically connected, for example welded, to the inner housing casing via the common connection point and to the outer housing casing having the bellows. Thus, the electrodes of the electrode stack can be separated from the cooling medium; no rubber seals are needed. By way of the movable pressure plate, hot gases (in the case of a thermal event) can be deflected precisely and deliberately by a specifically weakened predetermined rupture point in the diaphragm plate (or indentations).

According to one embodiment, the housing has a first connection on an upper side to receive the temperature control medium. The housing also has a second connection on an underside to receive the temperature control medium. The housing is configured for a flow of temperature control medium between the first connection and the second connection.

The temperature control medium or cooling fluid can flow between the first connection and the second connection during operation of the electrochemical storage cell and thus implement immersion cooling. The heat is carried away to the lateral surface of the cell. The bellows assists the thermal conduction by the cell being able to be cooled indirectly. In particular, the contacts (or terminals) of the cell, for example the cathode, can be cooled better although the immersion takes place substantially at the lateral surface.

According to one embodiment, the bellows has substantially parallel bellows corrugations. The bellows corrugations are structured on the outer housing casing by diameters that alternate in a wave-shaped manner. As a result, the surface of the housing is enlarged, which can lead to improved heat transport between the connections.

According to one embodiment, the bellows has substantially spiral bellows corrugations. The bellows corrugations form, for example, one or more spirals along the housing casing in the stacking direction. The temperature control medium can preferably flow along the spirals, so that a linear flow can be formed.

Furthermore, a method for setting a compression pressure of an electrochemical storage cell is proposed.

According to one embodiment, the method comprises the following steps. Firstly, an electrochemical storage cell is provided. The storage cell has a housing with an outer housing casing designed as a bellows and an electrode stack arranged in an interior of the housing. A compression pressure is set by engaging a compression tool in the bellows, wherein a first pressure plate, which is connected to the outer housing casing, imparts the compression pressure and exerts it on the electrode stack by way of elastic deformation of the bellows. Finally, the housing is closed at the set compression pressure.

The compression tool can, for example, engage in the bellows corrugations and deflect the bellows in order to set a desired compression pressure. By closing the housing (for example welding or crimping), the compression pressure is impressed and maintained by the spring action of the bellows.

Exemplary embodiments of the disclosure are described below with reference to the appended drawings. Further details, preferred embodiments and developments are evident therefrom. The same or identically acting constituent parts are each provided with the same reference signs in the figures. The constituent parts illustrated and the size relationships of the constituent parts to one another are not to be viewed as to scale. To the extent that components and constituent parts coincide in their function in the various figures, their description is not necessarily repeated for each of the following figures.

### BRIEF DESCRIPTION OF THE DRAWINGS

In detail:

FIGS. 1A, 1B show an exemplary embodiment of an electrochemical storage cell,

FIGS. 2A, 2B, 2C show an exemplary embodiment of an electrochemical storage cell in different states of charge,

FIGS. 3A, 3B show exemplary embodiments of a housing for an electrochemical storage cell having a bellows, and

FIGS. 4A to 4C show a further exemplary embodiment of an electrochemical storage cell.

### DETAILED DESCRIPTION OF THE DRAWINGS

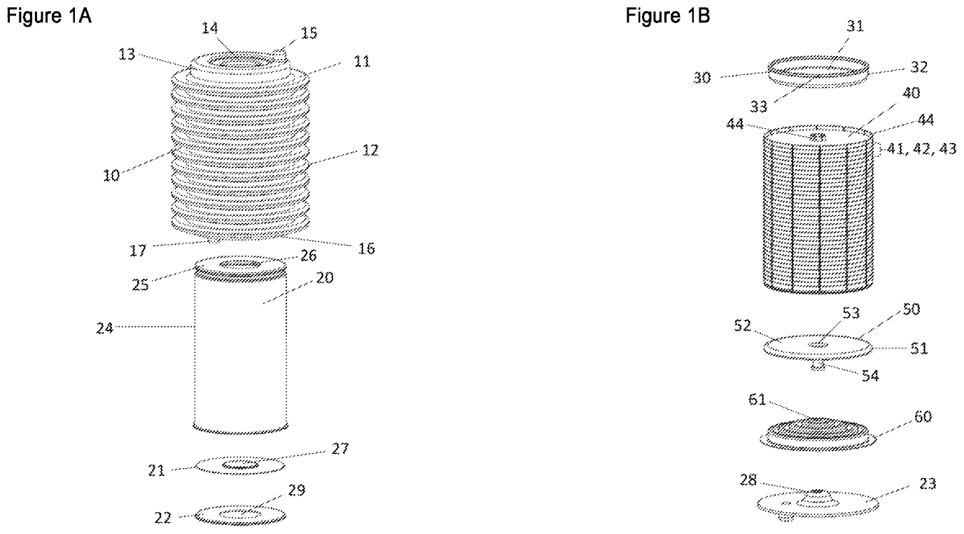

FIGS. 1A and 1B show an exemplary embodiment of an electrochemical storage cell. The drawings show an exploded illustration of the electrochemical storage cell, wherein the illustration is divided over FIGS. 1A and 1B and illustrates the electrochemical storage cell when the two drawings are viewed together. FIG. 1A shows a bellows 10 and a housing 20. Also shown are a contacting disk 21 and an insulating disk 22. FIG. 1B shows an upper pressure plate 30 and an electrode stack 40. Also shown are a lower pressure plate 50 and a diaphragm plate 60 and a lower housing cover 23. The insulating disk has an opening 28.

The bellows 10 comprises an outer housing casing 11 and a plurality of bellows corrugations 12. The bellows corrugations are structured in the outer housing casing by diameters that alternate in a wave-shaped manner. The inner diameters are chosen such that the housing 20 can be arranged in the interior of the bellows. In this example, the inner diameters are chosen such that the bellows encloses an inner cylinder volume. The outer diameters can be chosen such that a desired spring strength of the bellows is achieved. The spring strength of the bellows additionally depends, amongst other things, also on the material of the bellows, which is typically made of a metal, and the geometry of the bellows corrugations.

The bellows 10 has an annularly structured upper side 13 which is designed to accommodate the (cell) housing 20. An upper opening 14 is provided in the upper side. The bellows also has a first connection 15 on the upper side, via which the housing can receive a temperature control medium. The bellows has an annularly structured underside 16. The bellows has a second connection 17 on the underside to receive the temperature control medium. In this example, the housing 20 is configured as a round housing or cylinder and, for example, is made of metal or another pressure-resistant material. Alternatively, the electrochemical storage cell can also be designed as a prismatic cell, wherein the housing is likewise built up from a solid material, normally from metal.

In FIG. 1A, the housing 20 is shown in an external view. The housing delimits an internal receiving space (not shown) having a circular cross section, in which the electrode stack 40 can be accommodated. The housing comprises an inner housing casing 24 and a housing cover 25. In the longitudinal extension direction of the cylindrical housing, the receiving space is delimited on a first side by the housing cover 25. The inner housing casing 24 and the housing cover 25 are made from one piece in this example. Alternatively, the housing cover 25 can be screwed or connected mechanically in another way to the inner housing casing (for example welded or crimped) 24. The housing cover 25 also comprises a central cover opening 26 which permits access into the interior of the electrochemical storage cell, for example for putting an electrolyte in and/or as a pressure control valve.

The bellows 10 and the housing 20 together form a double-walled cell housing. An outer housing wall comprises the outer housing casing 11 of the bellows. An inner housing wall comprises the inner housing casing 24. The housing walls enclose a housing interspace, which can accommodate the temperature control medium, which can be supplied and/or discharged via the connections 15 and 17. As discussed further below, the bellows corrugations 12 can assist heat exchange with the surroundings and in addition, depending on configuration, can enable a laminar flow between the connections.

The housing 20 and also the bellows 10 can have a polygonal cross section, such as a hexagonal cross section. The storage cell, for example formed as a round cell, is a storage cell that can be produced inexpensively and time-efficiently. The round cell permits flat contacting between contacting elements and the respective electrode, which is electrically connected to the respective contacting element. Different further components of the electrochemical storage cell are presented below. If not explicitly stated, these components have an at least similar cross section to the housing, so that the components can be connectable to the housing or shaped so as to be movable in the latter. In the case of a round housing or a round cell, the cross section is substantially circular.

The contacting disk 21 can be inserted into the housing 20 and thus engage in the housing cover 25. For this purpose, the contacting disk is provided with an elevation 27 which fits into the central cover opening 26 in a form-fitting manner. The housing 20 can represent, for example, the positive pole or negative pole of the electrochemical storage cell, depending on how the cell is constructed. The polarization is predefined, for example, by the electrode stack 40. The contacting disk 21 promotes the contacting with the electrode stack 40 and corresponds to the positive pole or negative pole. The insulating disk 22 can optionally be arranged on or under the contacting disk 21 and is used to insulate the poles of the electrochemical cell electrically from one another. The contacting disk 21 and the insulating disk 22 can be screwed to the housing or mechanically connected in another way (for example welded or crimped).

The upper pressure plate 30 is shown in FIG. 1B. The upper pressure plate 30 is configured corresponding to the cross section of the housing 20, therefore substantially circular in this example. The pressure plate 30 comprises a pressure plate base 31 and a pressure plate rim 32. The pressure plate base 31 is configured to rest on an upper side of the electrode stack 40 in a form-fitting manner. The pressure plate rim 32 comprises a wall which extends in the manner of a plate along the circumference of the pressure plate 30 and is raised from the pressure plate base 31. Furthermore, the pressure plate 30 has a central pressure plate opening 33 which substantially coincides with the central cover opening 26 and can engage in the pressure plate opening 33 in a form-fitting manner. The pressure plate opening 33 is sufficiently large that it can accommodate an internal tube or the internal tube can be led through the pressure plate opening 33.

The upper pressure plate 30 is inserted into the housing 20 and permanently connected, for example welded, crimped or screwed, to the latter at the inner housing casing 24. “Permanently connected” here means that the connection is strong enough to withstand at least the compression pressure with which the electrode stack 40 can be compressed. The compression pressure can reach values in the two-digit kN range. As a result of the disk shape of the pressure plate 30 and/or as a result of the pressure plate rim 32, an upper internal cavity is formed between the housing cover 25 and the pressure plate base 31. The upper pressure plate 30 thus acts as a stop surface against which the electrode stack 40 is pressed when the compression pressure is built up. The electrode stack 40 is compressed by the corresponding opposing pressure. In other words, the upper pressure plate 30 has the technical effect of conducting the compression pressure or the compression force from the electrode layers of the electrode stack 40 into the bellows 10.

The electrode stack 40 comprises a plurality of stacks arranged on one another, wherein the respective stack has electrode layers arranged on one another, specifically at least one cathode layer 41, at least one anode layer 42 and at least one separator layer 43 arranged between the cathode layer and the anode layer. Furthermore, the stacks can have further layers such as insulators and metallic conductor foils (for example made of aluminum or copper). The cathode layer(s) 41 and the anode layer(s) 42 are electrically contacted via appropriate lugs 44 with an internal tube (not visible) and/or with the inner housing casing 24.

An upper side of the electrode stack 40 engages in a form-fitting manner on the upper pressure plate 30. The pressure plate base 31 rests, for example, substantially flatly on the upper side of the electrode stack 40. Since the upper pressure plate 30 is mechanically fixedly connected to the housing 20 and the housing casing 24, the pressure plate 30 is immovable under pressure.

The lower pressure plate 50 is configured corresponding to the cross section of the housing 20, i.e. substantially circular in this example. The lower pressure plate 50 comprises a pressure plate base 52 and a pressure plate rim 51. The pressure plate rim 51 optionally comprises a seal which extends along the periphery of the pressure plate 50 and seals off the pressure plate 50 from the inner housing casing 24 but keeps the pressure plate 50 movable in the stacking direction within the housing 20. In the embodiment illustrated, no seal is necessary, because the diaphragm plate 60 performs the sealing. Furthermore, the pressure plate 50 has a central pressure plate opening 53 which substantially coincides axially with the cover opening 23 so that, for example, the internal tube can be guided as far as the central pressure plate opening 53 and ends in this region.

The pressure plate rim 51 can, like a piston in an internal combustion engine, be flattened with respect to the pressure plate base 52, in order to avoid the pressure plate 50 tilting in the housing. Tilting is also prevented by the electrode stack 40. In addition, the pressure plate opening 53 is sufficiently large that, for example, it can accommodate the internal tube or the internal tube can be led through the pressure plate opening 53. The lower pressure plate 50 is inserted into the housing 20 and is movable in the stacking direction past the inner housing casing 24 and the internal tube. The lower pressure plate 50 comprises a tubular spigot 54 on a side facing away from the electrode stack 40.

The diaphragm plate 60 closes off the housing 20 on its underside and thus forms the inner wall of the double-walled housing at the housing base 23. For this purpose, the diaphragm plate 60 is screwed or mechanically connected in another way (for example welded or crimped) to the housing 20 or the inner housing casing 24. Alternatively, the diaphragm plate 60 and the housing casing can be made from one piece. The diaphragm plate 60 can be made from the same material as the housing 20 (for example from metal) or from another material, such as plastic. The diaphragm plate 60 has a corrugated structure which resembles the bellows 10, i.e. has waves and valleys. As opposed to the bellows 10, the diaphragm plate 60 is not designed to transmit a force. The introduction of the compression force on one side of the diaphragm plate 60 is transferred to the opposite side of the diaphragm plate 60, so that the plate 60 is loaded in compression. In other words, the diaphragm plate 60—in a manner similar to a photographic bellows—can follow a deflection of the bellows 10 in the length or a movement of the lower pressure plate 50. The diaphragm plate 60 has a central recess 61 in which the tubular spigot 54 can engage and is mechanically connected thereto.

The lower housing cover 23 closes off the double-walled housing on its underside. For this purpose, the lower housing cover 23 is screwed or mechanically connected in another way (for example welded or crimped) to the housing 20 or the outer housing casing 11. Alternatively, the lower housing cover 23 and the outer housing casing 11 can be made from one piece. The diaphragm plate 60 closes off the housing base from the interior relative to the electrode stack 40, so that the temperature control fluid remains in the cavity between the inner and outer wall of the housing 20 despite the compensation movement of the bellows 10. The lower housing cover 23 forms the underside of the bellows 10 and comprises the second connection 17. A central elevation 28 is mechanically connected to the tubular spigot 54 via the central recess 61 in the diaphragm plate 60.

The electrochemical storage cell is assembled by the components, as were shown in FIGS. 1A and 1B and described above, being guided into one another. The internal tube serves as an inner stacking axis which guides the bellows 10 and the housing 20 having the two pressure plates 30, 50 and the electrode stack 40 together and stacks them on one another. The internal tube 40 is guided through the upper opening 14, the cover opening 26, the pressure plate opening 33 and the pressure plate opening 53 for this purpose in particular. The internal tube ends in the central recess 61 in which the tubular spigot 54 engages and is mechanically connected thereto.

Assembled in this way, a compression pressure can be exerted on the electrode stack 40 by a spring action of the bellows 10. For this purpose, the bellows 10 can be elastically deformed by a compression tool, by the tool engaging in the bellows 10 or the bellows corrugations 12. As a result, the lower pressure plate 50, which is connected to the outer housing casing 11, imparts the compression pressure against the upper pressure plate 30 and thus on the electrode stack 40. The lower pressure plate 50 is movable in the housing 20 and can thus compensate for and track pressure fluctuations resulting from changes in the layer thicknesses in the electrode stack 40. The upper pressure plate 30, on the other hand, is permanently connected to the housing 20 and thus serves as an opposing pressure surface for the compression pressure. The electrode stack 40 is compressed by the corresponding opposing pressure.

Despite the compensation movement by the bellows 10 (which corresponds to a deflection of a mechanical spring), the diaphragm plate 60 ensures that the temperature control fluid remains in the cavity between the inner and outer wall of the housing 20. The double-walled housing enables both a constant compression pressure and also effective heat conduction or cooling in operation of the electrochemical storage cell.

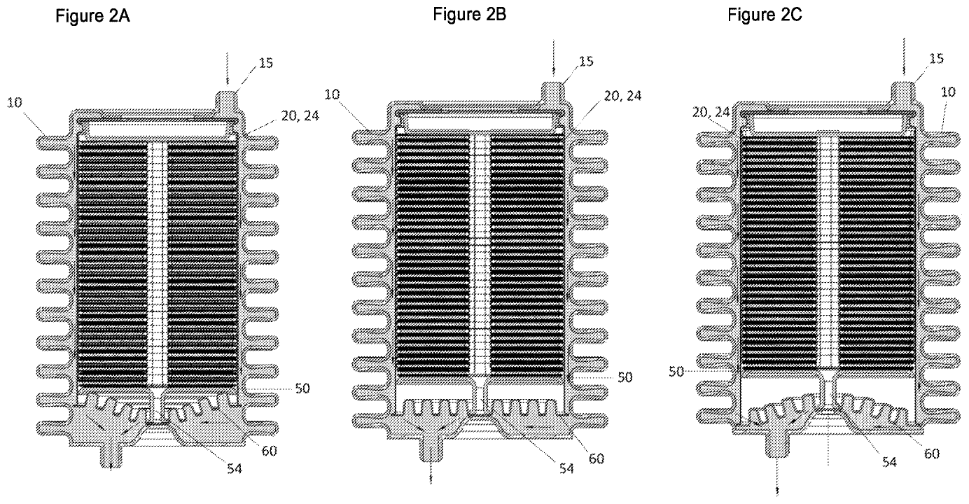

FIGS. 2A to 2C show an exemplary embodiment of an electrochemical storage cell in the charged, partly discharged and discharged state in a sectional illustration. This example corresponds to the exemplary embodiment shown in FIGS. 1A and 1B and described above in the assembled state. In FIG. 2A, the storage cell is charged; in FIG. 2B and in FIG. 2B, the storage cell is discharged.

The cell is configured, for example, as an all-solid-state cell, in particular as an anode-free all-solid-state battery (ASSB). The electrode stack 40 shown in section comprises a plurality of stacks arranged on one another. A stack has layers arranged on one another, specifically in each case a cathode layer 41, an anode layer 42 and a separator layer 43 arranged between the cathode layer 41 and the anode layer 42. Furthermore, the stacks can have further layers such as insulators and metallic conductor foils (for example made of aluminum or copper), which are not illustrated here. The cathode layers 41 and the anode layers 42 are electrically contacted by the internal tube or by the housing casing 24 via corresponding lugs 44.

In this example, a lithium battery is considered. Here, the cathode layers 41 in the charged, partly discharged and discharged state, have substantially the same layer thickness. By contrast, the layer thickness of the anode layers 42 changes as a function of the state of charge. In the charged state, anode layers 42 have been deposited. These are formed by the charging process by lithium being collected on conductor foils (for example copper foils). The electrode stack grows in height by the thickness of an anode layer x the number of layers. In the discharged state, no anode layer 42 is formed. Lithium is stored in the cathode layers 41. The lithium migrates from the anode layers through the separator layers 43 into the cathode layers 41 and is stored there. The different layer thicknesses are indicated in the drawings (cf. FIG. 2A: the storage cell is charged, FIG. 2B: the storage cell is partly discharged and FIG. 2C: the storage cell is discharged). In all the states shown, a desired compression pressure, which acts on the electrode stack 40, is set. This is mediated by the lower pressure plate 50 movable in the housing and fixed to the bellows 10.

Because of the charging and discharging processes described, a length expansion or length contraction of the electrode stack 40 along the stacking direction occurs. This can be seen in the sectional illustrations of FIGS. 2A to 2C by a different position of the lower pressure plate 50, for example with respect to the lower housing cover 23. The lower housing cover 23 forms the underside of the bellows 10 and closes off the double-walled housing. The lower housing cover 23 is connected to the tubular spigot 54 via the central elevation 24. The tubular spigot engages in the central recess 61 in the diaphragm plate 60. The central recess 61 is closed in regular operation and can rupture during a thermal event. For this purpose, the central recess 61 can have an indentation 55 which is used as a predetermined rupture point in the case of a thermal event (cf. FIG. 1C).

For example, the diaphragm plate 60 is welded together on the periphery of the housing 20. The underside of the tubular spigot can be welded together circularly and with the diaphragm plate 60. The underside of the diaphragm plate 60 can be welded together circularly with the central elevation 24 of the lower housing cover 23.

In the charged state shown in FIG. 2A, the anode layers 42 have been formed and the electrode stack 40 has its greatest longitudinal extent (in the stacking direction) in this state. Correspondingly, the bellows 10 also has its greatest longitudinal extent. Because of the mechanical connection via the tubular spigot 54, the lower pressure plate 50 moves into a position within the inner housing casing 24, which corresponds to the compression pressure. The compression pressure is set in a way corresponding to the longitudinal extent of the bellows. Since the tubular spigot is also connected to the diaphragm plate 60 and the diaphragm plate is connected to the housing 20, the diaphragm plate 60 bulges outward, i.e. in the direction of the housing base 23.

In the partly charged state shown in FIG. 2B, the anode layers 42 have been partly formed and the electrode stack 40 has a (medium) longitudinal extent reduced as compared with the greatest longitudinal extent in this state. Correspondingly, the bellows 10 also has a medium longitudinal extent. Because of the mechanical connection via the tubular spigot 54, the lower pressure plate 50 moves into a central position within the inner housing casing 24, which corresponds to the compression pressure. The compression pressure is set in a way corresponding to the longitudinal extent of the bellows 10. Since the tubular spigot is also connected to the diaphragm plate 60 and the diaphragm plate 60 is connected to the housing 20, the diaphragm plate 60 bulges outward less; in the example shown, the diaphragm is not bulged at all.

In the discharged state shown in FIG. 2C, the anode layers 42 have no longer been formed and the electrode stack 40 has a smallest longitudinal extent in this state. Correspondingly, the bellows 10 also has a smallest longitudinal extent. Because of the mechanical connection via the tubular spigot 54, the lower pressure plate 50 moves into a position within the inner housing casing, which corresponds to the compression pressure. The compression pressure is set in a way corresponding to the longitudinal extent of the bellows 10. Since the tubular spigot is also connected to the diaphragm plate 60 and the diaphragm plate 60 is connected to the housing 20, the diaphragm plate 60 bulges inward, i.e. in the direction of the housing cover 25.

In the different states of charge, a cavity which accommodates the temperature control fluid is formed. Cooling is ensured by the bellows 10 despite the movement. Furthermore, the diaphragm plate 60 or else the lower housing cover 23 can each have an indentation 55 in the area of the tubular spigot 54. The indentation 55 is illustrated by way of example in FIG. 2C and can be configured to rupture during a thermal event. Thus, it is possible to deflect hot gases out of the electrode stack 40 precisely out of the housing 20 via the tubular spigot 54 and the indentation 55. In this way, the electrochemical storage cell can be expanded by an improved safety function in addition to the functions of compensating for the compression pressure and effective cooling.

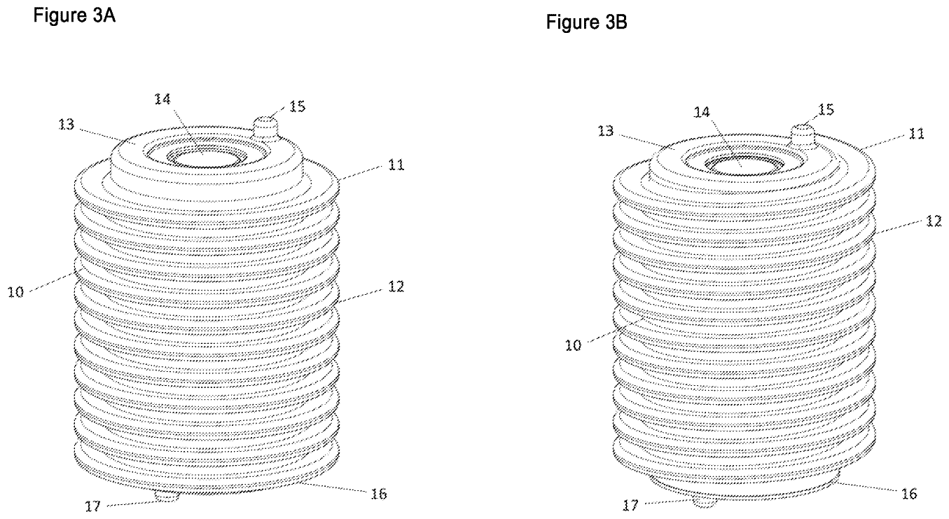

FIGS. 3A and 3B show exemplary embodiments of a housing for an electrochemical storage cell having a bellows. FIG. 3A shows an external view of a bellows having substantially parallel bellows corrugations. The bellows corrugations are structured on the outer housing casing by diameters that alternate in a wave-shaped manner. As a result, the surface of the housing is enlarged, which can lead to improved heat transport between the connections. This embodiment is also shown in FIGS. 2A to 2C. There, a possible flow of the temperature control fluid between the connections is also indicated by arrows. In the case of parallel bellows corrugations, the flow can be set to be laminar when the flow rate does not exceed a specific value. FIG. 3A shows an external view of a bellows having substantially spiral bellows corrugations. The bellows corrugations form one or more spirals, for example, along the housing casing in the stacking direction. The temperature control fluid can preferably flow along the spirals, so that a linear flow can be formed. This has the further advantage that the flow can be set to be laminar even at a higher flow rate.

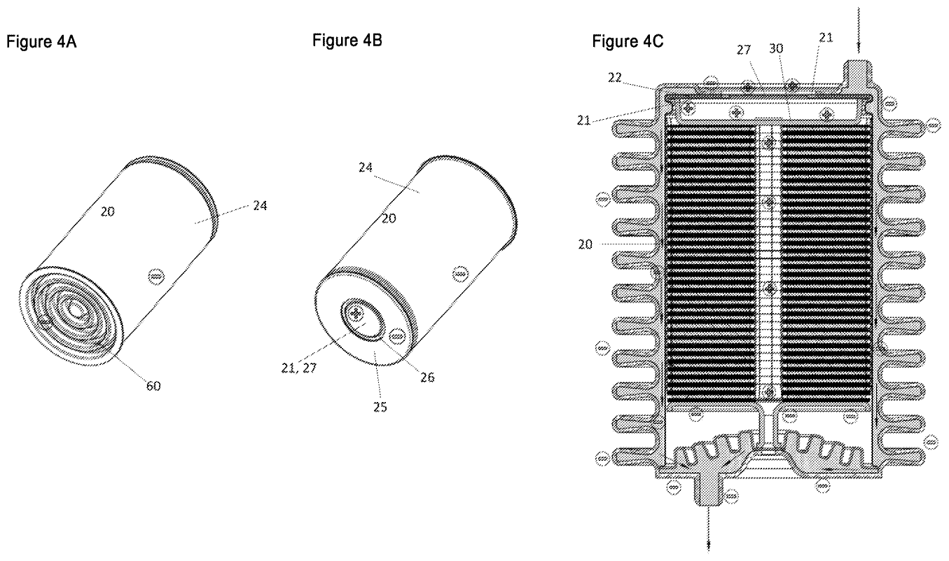

FIGS. 4A to 4C show a further exemplary embodiment of an electrochemical storage cell. In particular, the drawings show a possible electrical polarity of the storage cell. In the drawings, the negative pole is designated by (−) and the positive pole by (+). The polarity illustrated is an example, the negative pole and the positive pole being interchangeable.

The housing 20 is shown in FIG. 4A. The inner housing casing 24 and the diaphragm plate 60 are placed on the same pole, in this example on the negative pole (−). The housing cover is also placed on the same pole, here therefore on the negative pole (−), as shown in FIG. 4B. Furthermore, the contacting disk 21, which is placed on the positive pole (+), is shown.

FIG. 4C shows the electrochemical storage cell with the polarity introduced in FIGS. 4A and 4B in section. It can be seen that the electrode stack is electrically conductively connected to the internal tube by the lugs. As a result, the internal tube rests, for example, on the positive pole (+). The upper pressure plate rests on the electrode stack and is contacted by the internal tube. The upper pressure plate accordingly likewise rests on the positive pole (+). The upper pressure plate and the internal tube are insulated from the housing and bellows by the insulation plate 22. The contacting disk 21 is likewise insulated from the housing and the bellows and rests on the positive pole (+). The electrode stack is electrically conductively connected to the inner and outer housing casing by the lugs. Therefore, the housing 20 and the bellows 10 rest on the negative pole (−). The lower pressure plate 50 is in electrical contact with the electrode stack and, through the layer sequence of the latter, likewise on the negative pole (−). As a result of the selected contacting, the electrochemical storage cell is polarized such that the positive pole (+) can be tapped off via the upper side having the contacting disk 21 and the negative pole (−) can be tapped off by the underside having the housing cover.

Although the invention has been illustrated and described in detail with reference to exemplary embodiments, the invention is not restricted by the exemplary embodiments. Instead, other variations of the invention can be derived therefrom by a person skilled in the art without departing from the protective scope of the invention defined by the claims.

List of reference signs

| | |
|---|---|
| 10 | Bellows |
| 11 | Outer housing casing |
| 12 | Bellows corrugations |
| 13 | Annularly structured upper side |
| 14 | Upper opening |
| 15 | First connection |
| 16 | Annularly structured underside |
| 17 | Second connection |
| 20 | Housing |
| 21 | Contacting disk |
| 22 | Insulating disk |
| 23 | Lower housing cover |
| 24 | Inner housing casing |
| 25 | Housing cover |
| 26 | Central cover opening |
| 27 | Elevation |
| 28 | Elevation |
| 29 | Opening in the insulating plate |
| 30 | Upper pressure plate |
| 31 | Pressure plate base |
| 32 | Pressure plate rim |
| 33 | Central pressure plate opening |
| 40 | Electrode stack |
| 41 | Cathode layer |
| 42 | Anode layer |
| 43 | Separator layer |
| 44 | Lugs |
| 50 | Lower pressure plate |
| 51 | Pressure plate rim |
| 52 | Pressure plate base |
| 53 | Central pressure plate opening |
| 54 | Tubular spigot |
| 55 | Indentation |
| 60 | Diaphragm plate |
| 61 | Central recess |

1-10. (canceled)

11. An electrochemical storage cell comprising:
a housing having an outer housing casing, the outer housing casing comprising a bellows,
an electrode stack arranged in an interior of the housing, and
a first pressure plate connected to the outer housing casing and configured to exert a compression pressure on the electrode stack, mediated by elastic deformation of the bellows.

12. The storage cell according to claim 11, wherein
the first pressure plate is configured to be moveable along a stacking direction of the electrode stack and is firmly connected to a housing base,
the first pressure plate is configured to exert the compression pressure on an underside of the electrode stack, mediated by the elastic deformation of the bellows.

13. The storage cell according to claim 11, wherein
a second pressure plate is connected to a housing cover, the second pressure plate being immoveable in the housing and resting on an upper side of the electrode stack, and
the second pressure plate is configured to exert a pressure on the electrode stack in opposition to the compression pressure.

14. The storage cell according to claim 11, wherein
the housing is double-walled and comprises a housing interspace which is delimited by the outer housing casing and an inner housing casing,
the electrode stack is arranged in an interior of the housing that is delimited by the inner housing casing, and
the housing interspace is configured to accommodate a temperature control medium.

15. The storage cell according to claim 11, wherein
the housing base is double-walled and is configured to accommodate a temperature control medium,
an inner wall of the housing base is connected to an inner housing casing,
an outer wall of the housing base is connected to the outer housing casing, and
the first pressure plate is connected to the inner and the outer wall of the housing base via a common connection point.

16. The storage cell according to claim 15, wherein the inner wall of the housing base comprises a diaphragm plate.

17. The storage cell according to claim 11, wherein
the housing has a first connection on an upper side to receive a temperature control medium,
the housing has a second connection on an underside to receive the temperature control medium, and
the housing is configured for a flow of the temperature control medium between the first connection and the second connection.

18. The storage cell according to claim 11, wherein the bellows has substantially parallel bellows corrugations.

19. The storage cell according to claim 11, wherein the bellows has substantially spiral bellows corrugations.

20. A method for adjusting a compression pressure of an electrochemical storage cell, the method comprising:
providing an electrochemical storage cell having a housing with an outer housing casing configured as a bellows and an electrode stack arranged in an interior of the housing;
adjusting the compression pressure by engaging a compression tool in the bellows,
wherein a first pressure plate connected to the outer housing casing exerts the compression pressure on the electrode stack mediated by elastic deformation of the bellows; and
closing the housing at a set compression pressure.
